(19) United States
(12) Patent Application Publication
(10) Pub. No.: US 2008/0300329 A1
(43) Pub. Date: Dec. 4, 2008

(54) Modified Open-Cell Foams, and Method for the Production Thereof

(75) Inventors: Andreas Fechtenkotter, Ludwigshafen (DE); Michael Ehle, Ludwigshafen (DE); Stefan Frenzel, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/571,802

(22) PCT Filed: Jul. 14, 2005
(86) PCT No.: PCT/EP2005/007639

§ 371 Date: Jan. 8, 2007

(30) Foreign Application Priority Data
Jul. 16, 2004 (DE) 10 2004 034 604.6

(51) Int. Cl. C08J 9/00

(52) U.S. Cl. 521/65; 521/189; 521/149

(57) ABSTRACT

Modified open-cell foams with a density in the range from 5 to 1000 kg/m³ and with an average pore diameter in the range from 1 μm to 1 mm, comprising an amount in the range from 1 to 2500% by weight based on the weight of the unmodified open-cell foam, of at least one polymer which is solid at room temperature and which contains carboxy groups and/or which contains carboxylic ester groups, and which has a molar mass Mₙ in the range from 1000 to 1000 000 g/mol.

The present invention relates to modified open-cell foams with a density in the range from 5 to 1000 kg/m³ and with an average pore diameter in the range from 1 μm to 1 mm, comprising an amount in the range from 1 to 2500% by weight, based on the weight of the unmodified open-cell foam, of at least one polymer which is solid at room temperature and which contains carboxy groups and/or which contains carboxylic ester groups, and which has a molar mass Mₙ in the range from 1000 to 1 000 000 g/mol.

The present invention further relates to a process for production of inventive modified open-cell foams, and to the use of inventive modified open-cell foams for production of cleaning materials, filters, humidifiers, water distributors, packaging elements, sound-deadening elements, or buildings-insulation materials.

Foams, specifically what are known as open-cell foams, are used in numerous sectors. In particular open-cell foams composed of synthetic materials have proven versatile. By way of example, mention may be made of seat cushions, filter materials, air-conditioning systems, and automobile parts, and also cleaning materials.

Cleaning materials produced from foams are found to loose their cleaning action completely, because of irreversible damage after a relatively short service time, for example after about 10 minutes. Producers of cleaning materials, for example wipers, therefore recommend disposal of cleaning materials after an appropriate service time which is generally very brief, e.g. 10 minutes.

EP 0 922 563 indicates the feasibility of laminating melamine resin foams to thin, tear-resistant outer layers, e.g. fiber nonwovens, for, by way of example, 2 minutes at pressures of from 2 to 5 to 200 bar and temperatures in the range from 80 to 250° C. This gives dimensionally stable components.

U.S. Pat. No. 6,608,118 proposes compressing melamine foams with exposure to heat, for example compressing them at 270° C. for 4 minutes, in order to achieve better mechanical properties.

EP 0 633 283 and DE 100 11 388 recommend reinforcing melamine resin foams by, for example, impregnating them with a silicone emulsion. However, silicone-emulsion-impregnated foams are not useful cleaning materials, because their use results in streaking and oily surfaces. DE 100 11 388 further recommends spraying melamine resin foams with monomeric fluorinated alkyl esters in order to render them oil-repellent.

However, there is still room for improvement in the technical properties of foams known from the prior art, with respect to cleaning action, stability, and water- or oil-absorption.

An object was therefore to provide foams which avoid the disadvantages of the materials known from the prior art. A further object was to provide a process for production of novel foams. Another object was to provide uses for foams, and an object was to provide a method for the use of foams.

The modified foams defined at the outset have accordingly been found, and these are also termed inventive foams hereinafter.

Inventive modified foams are open-cell foams, i.e. foams in which at least 50% of all of the lamellae are open, preferably from 60 to 100%, and particularly preferably from 65 to 99.9%, determined to DIN ISQ 4590.

The inventive modified foams are preferably rigid foams, which for the purposes of the present invention are foams whose compressive strength, determined to DIN 53577, is 1 kPa or above at 40% compression.

Inventive modified foams have a density in the range from 5 to 1000 kg/m³, preferably from 6 to 500 kg/m³ and particularly preferably in the range from 7 to 300 kg/m3.

Inventive modified foams have an average pore diameter (number-average) in the range from 1 μm to 1 mm, preferably from 50 to 500 μm, determined via evaluation of micrographs of sections.

In one embodiment of the present invention, inventive modified foams have a BET surface area in the range from 0.1 to 50 m²/g, preferably from 0.5 to 20 m²/g, determined to DIN 66131.

In one embodiment of the present invention, inventive modified foams have a sound-absorption level above 50%, preferably at least 90%, in specific cases up to 100%, measured to DIN 52215 at a frequency of 2000 Hz and a layer thickness of 50 mm of relevant foam.

In one specific embodiment of the present invention, inventive modified foams have a sound-absorption level above 0.5, and in specific cases up to 1, measured to D N 52212 at a frequency of 2000 Hz and a layer thickness of 40 mm of the relevant foam.

Inventive modified foams preferably comprise an amount in the range from 1 to 2500% by weight, preferably from 20 to 500% by weight, based on the weight of the corresponding unmodified foam (a), of at least one polymer (b) which is solid at room temperature and which contains carboxy groups and/or which contains carboxylic ester groups, and which has a molar mass Mₙ in the range from 1000 to 1 000 000 g/mol, preferably from 1500 to 500 000 g/mol, particularly preferably from 2000 to 200 000 g/mol, and very particularly preferably up to 50 000 g/mol.

In one embodiment of the present invention, polymers (b) which are solid at room temperature and which contain carboxy groups and/or which contain carboxylic ester groups are polymers whose melting point is above 25° C., preferably above 50° C., determined via DSC.

Polymers (b) which are solid at room temperature and which contain carboxy groups and/or which contain carboxylic ester groups may be homopolymers or copolymers of ethylenically unsaturated mona or dicarboxylic acids.

In one preferred embodiment of the present invention, at least one polymer (b) which is solid at room temperature and which contains carboxy groups and/or which contains carboxylic ester groups is a copolymer obtainable via copolymerization of

(A) ethylene,
(B) at least one ethylenically unsaturated carboxylic acid,
(C) if appropriate, other comonomers.

In one embodiment, these are copolymers selected from styrene-acrylonitrile-C₁-C₁₀-alkyl (meth)acrylate terpolymers.

By way of examples, other comonomers (C) may be selected from the group of the C₁-C₁₀-alkyl esters of ethylenically unsaturated mono- and dicarboxylic acids, vinyl, allyl, and methallyl esters of C₁-C₁₀-alkanecarboxylic acids or of formic acid, vinylaromatic compounds, such as styrene, isobutene and α-olefins, such as CH₂═CH-n-C₁₆H₃₃, CH₂═CH-n-C₁₈H₃₇, CH₂═CH-n-C₂₀H₄₁, and CH₂═CH-n-C₂₂H₄₅, and mixtures of the abovementioned comonomers.

In one embodiment of the present invention, inventive open-cell modified foams are those based on synthetic organic foam, for example based on organic unmodified foams, such as foams based on polyurethane foams or on aminoplastic foams, for example composed of urea-formaldehyde resins, or else foams based on phenol-formaldehyde resins, and in particular foams based on polyurethanes or on aminoplastic-formaldehyde resins, in particular on melamine-formaldehyde resins, and for the purposes of the present invention foams based on polyurethanes are also termed polyurethane foams and foams based on melamine-formaldehyde resins are also termed melamine foams.

This means that inventive foams are produced from open-cell foams which comprise synthetic organic materials, preferably polyurethane foams or aminoplastic foams, and in particular melamine foams.

In another embodiment of the present invention, inventive open-cell modified foams are those based on inorganic materials, for example on metals or glass, in particular in the form of glass wool or of metal foam.

The present invention also provides a process for production of inventive modified foams, hereinafter also termed an inventive production process. The inventive production process comprises bringing (a) open-cell foams with a density in the range from 5 to 500 kg/1M³ and with an average pore diameter in the range from 1 um to 1 mm (b) into contact with at least one polymer which is solid at room temperature and which contains carboxy groups and/or which contains carboxylic ester groups, and which has a molar mass Mₙ in the range from 1000 to 1 000 000 g/mol in molten, dissolved, or dispersed form.

For the purposes of the present invention, the unmodified open-cell foams (a) used to carry out the inventive process are very generally also termed unmodified foams (a) or open-cell foams (a). The unmodified open-cell foams (a) used to carry out the inventive process are described in more detail below.

To carry out the inventive production process, the starting material used comprises open-cell foams (a), in particular foams in which at least 50% of all of the Lamellae are open, preferably from 60 to 100%, and particularly preferably from 65 to 99.9%, determined to DIN ISO 4590.

Foams (a) used as starting materials are preferably rigid foams, which for the purposes of the present invention are foams whose compressive strength, determined to DIN 53577, is 1 kPa or more at 40% compression. Foams (a) used as starting material have a density in the range from 5 to 500 kg/m³, preferably from 6 to 300 kg/m³, and particularly preferably in the range from 7 to 300 kg/m³.

Open-cell foams (a) used as starting material have an average pore diameter (number-average) in the range from 1 um to 1 mm, preferably from 50 to 500 um, determined via evaluation of micrographs of sections.

In one embodiment of the present invention, open-cell foams (a) used as starting material may have at most 20, preferably at most 15, and particularly preferably at most 10 pores per m² of diameter in the range up to 20 mm. The remaining pores usually have a smaller diameter.

In one embodiment of the present invention, open-cell foams (a) used as starting material have a BET surface area in the range from 0.1 to 50 m²/g, preferably from 0.5 to 20 m²/g, determined to DIN 66131.

In one embodiment of the present invention, foams (a) used as starting material have a sound-absorption level above 50%, measured to DIN 52215 at a frequency of 2000 Hz and a layer thickness of 50 mm of the relevant foam (a).

In one specific embodiment of the present invention, open-cell foams (a) used as starting material have a sound-absorption level above 0.5, measured to DIN 52212 at a frequency of 2000 Hz and a layer thickness of 40 mm of the relevant foam (a).

Open-cell foams (a) used as starting material may have any desired geometric shapes, e.g. sheets, spheres, cylinders, powders, cubes, flakes, blocks, saddles, bars, or square columns. The size dimensions of foams (a) used as starting material are non-critical. In one embodiment of the present invention, the starting materials comprises open-cell foams (a) composed of synthetic organic material, and preferably comprises polyurethane foams or melamine foams.

Polyurethane foams particularly suitable as starting material for carrying out the inventive process are known per se. By way of example, they are produced via reaction of
i) one or more polyisocyanates, i.e. compounds having two or more isocyanate groups,
ii) with one or more compounds having at least two groups reactive toward isocyanate, in the presence of
iii) one or more blowing agents,
iv) one or more starters,
v) and one or more catalysts, and
vi) cell openers.
   Starters iv) and blowing agents iii) can be identical here.

Examples of suitable polyisocyanates i) are aliphatic, cycloaliphatic, araliphatic and preferably aromatic polyfunctional compounds known per se and having two or more isocyanate groups.

Specific examples are:

C₄-C₁₂-alkylene diisocyanates, preferably hexamethylene 1,6-diisocyanate; cycloaliphatic diisocyanates such as cyclohexane 1,3- and 1,4-diisocyanate and any mixtures of these isomers, 1-isocyanato-3,3,5-trimethyl-5-isocyanatomethyl-cyclohexane (isophorone diisocyanate, IPDI),

preferably aromatic diisocyanates and polyisocyanates such as tolylene 2,4- and 2,6-diisocyanate and corresponding isomer mixtures, diphenylmethane 4,4′-, 2,4′- and 2,2′-diisocyanate and corresponding isomer mixtures, mixtures of diphenylmethane 4,4′- and 2,4′-diisocyanates, polyphenyl polymethylene polyisocyanates, mixtures of diphenylmethane 4,4′-, 2,4′- and 2,2′-diisocyanates and polyphenyl polymethylene polyisocyanates (crude MDI), and mixtures of crude MDI with tolylene diisocyanates. Polyisocyanates can be used individual y or in the form of mixtures.

Examples of compounds II) having at least two groups reactive toward isocyanate are diols and polyols, in particular polyether polyols (polyalkylene glycols), these being prepared by methods known per se, for example by polymerization of one or more alkylene oxides, for example ethylene oxide, propylene oxide or butylene oxide, in the presence of alkali metal hydroxides as catalysts.

Very particularly preferred compounds II) are ethylene glycol, propylene glycol, butylene glycol, 1,3-propanediol, 1,4-butanediol, 1,6-hexanediol, diethylene glycol, dipropylene glycol, triethylene glycol, tripropylene glycol, tetraethylene glycol, pentaethylene glycol, hexaethylene glycol.

Suitable blowing agents iii) are: water, inert gases, in particular carbon dioxide, and physical blowing agents. Physical blowing agents are compounds which are inert toward the starting components and are usually liquid at room temperature and vaporize under the conditions of the urethane reaction. The boiling point of these compounds is preferably below 110° C., in particular below 80° C. Among physical blowing agents are also inert gases which are introduced into the starting components i) and ii) or dissolved therein, for example carbon dioxide, nitrogen or noble gases.

Suitable compounds which are liquid at room temperature are usually selected from the group comprising alkanes and/or cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are: propane, n-butane, isobutane and cyclobutane, n-pentane, isopentane and cyclopentane, cyclohexane, dimethyl ether, methyl ethyl ether, methyl tert-butyl ether, methyl formate, acetone and fluorinated alkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, 1,1,1-trifluoro-2,2,2-trichloroethane, 1,1,2-trifluoro-1,2,2-trichloroethane, difluoroethanes and heptafluoropropane. The physical blowing agents mentioned can be used either alone or in any combinations with one another.

The use of perfluoroalkanes for producing fine cells is known from EP-A 0 351 614.

Examples of suitable starters iv) are: water, organic dicarboxylic acids, aliphatic and aromatic, optionally N-monoalkyl-, N,N- and N,N′-dialkyl-substituted diamines having from 1 to 4 carbon atoms in the alkyl radical, e.g. optionally N-monoalkyl- and N,N-dialkyl-substituted ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, aniline, phenylenediamines, 2,3-, 2,4-, 3,4- and 2,6-tolylenediamine and 4,4′-, 2,4′- and 2,2′-diaminodiphenylmethane.

Suitable catalysts v) are the catalysts known in polyurethane chemistry, for example tertiary amines such as triethylamine, dimethylcyclohexylamine, N-methylmorpholine, N,N′-dimethylpiperazine, 2-(dimethylaminoethoxy)ethanol, diazabicyclo[2.2.2]octane and the like and also, in particular, organic metal compounds such as titanic esters, iron compounds such as iron(III) acetylacetonate, tin compounds, e.g. tin diacetate, tin dioctoate, tin dilaurate or dialkyltin salts of aliphatic carboxylic acids, e.g. dibutyltin diacetate and dibutyltin dilaurate.

Examples of cell openers vi) are polar polyether polyols (polyalkylene glycols) having high ethylene oxide content in the chain, preferably at least 50%. These have a cell opening effect via demixing and effect on surface tension during foaming.

i) to vi) are used in the quantitative ratios customary in polyurethane chemistry.

Melamine foams particularly suitable as starting material for carrying out the inventive production process are known per se. By way of example, they are produced via foaming of
vii) a melamine-formaldehyde precondensate which may comprise other carbonyl compounds, such as aldehydes, co-condensed alongside for aldehyde,
viii) one or more blowing agents,
ix) one or more emulsifiers,
x) one or more hardeners.

Melamine-formaldehyde precondensates vii) may be unmodified precondensates, or else may be modified precondensates, and by way of example up to 20 mol % of the melamine may have been replaced by other thermoset-forming materials known per se, e.g. alkyl-substituted melamine, urea, urethane, carboxamides, dicyandiamide, guanidine, sulfuryl amide, sulfonamides, aliphatic amines, phenol, and phenol derivatives. Examples of other carbonyl compounds which may be present co-condensed alongside formaldehyde in modified melamine-formaldehyde precondensates are acetaldehyde, trimethylolacetaldehyde, acrolein, furfurol, glyoxal, phthalaldehyde and terephthalaldehyde.

Blowing agents viii) used may be the same as the compounds described in iii).

Emulsifiers ix) used may be conventional non-ionic, anionic, cationic, or betainic surfactants, in particular C₁₂-C₃₀-alkylsulfonates, preferably C₁₂-C₁₈-alkylsulfonates, and polyethoxylated C₁₀-C₂₀-alkyl alcohols, in particular having the formula R⁶—O(CH₂—CH₂—)ₓ—H, where R⁶ is selected from C₁₀-C₂₀-alkyl and x may be, by way of example, a whole number in the range from 5 to 100

Possible hardeners x) are, in particular, acidic compounds such as inorganic Brønsted acids, e.g. sulfuric acid or phosphoric acid, organic Brønsted acids such as acetic acid or formic acid, Lewis acids and also latent acids.

Examples of suitable melamine foams are described in EP-A 0 017 672.

Foams (a) used as starting material may, of course, also comprise additives customary in foam chemistry, for example antioxidants, flame retardants, fillers, colorants such as pigments or dyes, and biocides, such as

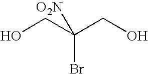

Another starting material used for carrying out the present invention is at least one polymer (b) which is solid at room temperature and which contains carboxy groups and/or which contains carboxylic ester groups, and which has a molar mass Mₙ in the range from 1000 to 1 000 000 g/mol, in molten or preferably dissolved or dispersed form, also hereinafter termed polymer (b) solid at room temperature. Polymer (b) which is solid at room temperature and which contains carboxy groups and/or which contains carboxylic ester groups and which is used according to the invention is described in more detail below.

According to the invention, open-cell foams (a) characterized above are brought into contact with at least one polymer (b) which is solid at room temperature and which contains carboxy groups and/or which contains carboxylic ester groups, and which has a molar mass Mₙ in the range from 1000 to 1 000 000 g/mol, preferably from 1500 to 500 000 g/mol, particularly preferably from 2000 to 200 000 g/mol, and very particularly preferably up to 50 000 g/mol, in molten or preferably dissolved or dispersed form.

After the inventive contact, modified foams preferably comprise, according to the invention, an amount in the range from 1 to 2500% by weight, preferably from 10 to 1000% by weight, based on the weight of the corresponding unmodified open-cell foam (a), of at least one film-forming polymer (b) which contains carboxy groups and/or which contains carboxylic ester groups, and which has a molar mass Mₙ in the range from 1000 to 1 000 000 g/mol, preferably from 1500 to 500 000 g/mol, particularly preferably from 2000 to 200 000 g/mol, and very particularly preferably up to 50 000 g/mol. Polymers (b) used according to the invention which are solid at room temperature and which contain carboxy groups and/or which contain carboxylic ester groups are organic polymers or copolymers, Polymers (b) used according to the invention which are solid at room temperature and which contain carboxy groups and/or which contain carboxylic ester groups may be homopolymers or copolymers of ethylenically unsaturated mono- or dicarboxylic acids.

In one embodiment of the present invention, polymers (b) used according to the invention which are solid at room temperature and which contain carboxy groups and/or which contain carboxylic ester groups are organic polymers other than the material from which open-cell foam (a) has been produced.

Polymer (b) used according to the invention which are solid at room temperature and which contain carboxy groups and/or which contain carboxylic ester groups may be polymers whose glass transition temperature T_{g} is in the range from −50 to 150° C., preferably from −25 to 120° C., and particularly preferably from −20 to 100° C.

In one preferred embodiment of the present invention, at least one polymer (b) which is solid at room temperature and which contains carboxy groups and/or which contains carboxylic ester groups is a copolymer of at least one ethylenically unsaturated carboxylic acid, selected from ethylenically unsaturated mono- and dicarboxylic acids, and in particular is a copolymer of (meth)acrylic acid.

In one preferred embodiment of the present invention, at least polymer (b) which is solid at room temperature and which contains carboxy groups and/or which contains carboxylic ester groups is a copolymer obtainable via copolymenrization of

(A) ethylene,
(B) at least one ethylenically unsaturated carboxylic acid,
(C) if appropriate, other comonomers.

Particularly preferred polymers (b) which are solid at room temperature and which contain carboxy groups and/or which contain carboxylic ester groups will be described in more detail below.

Polymer (b) which is solid at room temperature and which contains carboxy groups and/or which contains carboxylic ester groups is particularly preferably ethylene polymers in which copolymerized comonomers comprise:

(A) from 60 to 950/by weight, preferably from 65 to 850/by weight of ethylene and
(B) from 5 to 40% by weight, preferably from 15 to 35% by weight, of at least one ethylenically unsaturated carboxylic acid,
the % by weight data here being based on the entire polymer (b) which is solid at room temperature and which contains carboxy groups and/or which contains carboxylic ester groups.

At least one ethylenically unsaturated carboxylic acid is preferably a carboxylic acid of the general formula I

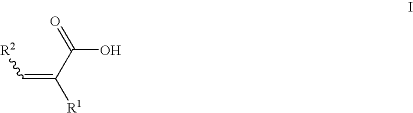

The definitions of the radicals in the formula I here are as follows:
R¹ selected from hydrogen and
   C₁-C₁₀-alkyl, such as methyl, ethyl, n-propyl, isopropyl, n-butyl, isobutyl, sec-butyl, tert-butyl n-pentyl, isopentyl, sec-pentyl, neopentyl, 1,2-dimethylpropyl, isoamyl, n-hexyl isohexyl, sec-hexyl, n-heptyl, n-octyl, n-nonyl, n-decyl-particularly preferably C₁-C₄-alkyl, such as methyl, ethyl, n-propyl, isopropyl, n-butyl, isobutyl, sec-butyl, and tertbutyl;
R² selected from hydrogen
   C₁-C₁₀-alkyl, such as methyl, ethyl, n-propyl, isopropyl, n-butyl, isobutyl, sac-butyl, tert-butyl, n-pentyl, isopentyl, sec-pentyl, neopentyl 1,2-dimethylpropyl, isoamyl, n-hexyl, isohexyl, sec-hexyl n-heptyl, n-octyl, n-nonyl, n-decyl; particularly preferably C₁-C₄-alkyl, such as methyl, ethyl, n-propyl, isopropyl, n-butyl, isobutyl, sec-butyl, and tert-butyl;
   COOH, COOCH₃, COOCH₅.

It is very particularly preferable that R² is hydrogen and that R¹ is hydrogen or methyl.

Ethylene copolymers used according to the invention as polymer (b) which is solid at room temperature and which contains carboxy groups and/or which contains carboxylic ester groups, may comprise up to 40% by weight, preferably up to 35% by weight, based in each case on the entirety of ethylene and copolymerized ethylenically unsaturated carboxylic acid(s), of one or more other copolymerized comonomers (C), e.g.
vinyl, allyl, and methallyl esters of C₁-C₁₀-alkanecarboxylic acids or of formic acid, e.g. vinyl formate, vinyl propionate, and in particular vinyl acetate,
one or more ethylenically unsaturated carboxylic esters, preferably of the formula

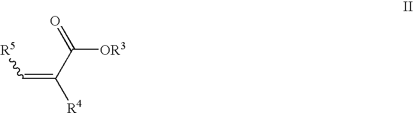

R³ selected from C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl; particularly preferably C₁-C₄-alkyl, such as methyl, ethyl, n-propyl, isopropyl, n-butyl, isobutyl, sec-butyl, and tert-butyl.
R⁴ selected from hydrogen,
   C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, iso-amyl, n-hexyl, isohexyl, sec-hexyl, n-heptyl, n-octyl, n-nonyl, n-decyl; particularly preferably C₁-C₄-alkyl, such as methyl, ethyl, n-propyl, isopropyl, n-butyl, isobutyl, sec-butyl, and tert-butyl;
R⁵ selected from hydrogen,
   C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, iso-amyl, n-hexyl, isohexyl, sec-hexyl, n-heptyl, n-octyl, n-nonyl, n-decyl; particularly preferably C₁-C₄-alkyl, such as methyl, ethyl, n-propyl, isopropyl, n-butyl, isobutyl, sec-butyl, and tert-butyl;
   COOCH₃, COOC₂H₅,
      and moreover
   vinylaromatic compounds, such as α-methylstyrene and in particular styrene,
   isobutene, and
   α-olefins, such as CH₂═CH-n-C₁₆H₃₃, CH₂═CH-n-C₁₈H₃₇, CH₂═CH-n-C₂₀H₄₁, and CH₂═CH-n-C₂₂H₄₅.

In formula II, R⁵ is very particularly preferably hydrogen and R⁴ is very particularly preferably hydrogen or methyl.

In formula II, R⁵ is very particularly preferably hydrogen and R⁴ is very particularly preferably hydrogen or methyl, and R³ has very particularly preferably been selected from methyl, ethyl, n-butyl, and 2-ethylhexyl.

Ethylene copolymers described above, composed of ethylene and of at least one ethylenically unsaturated carboxylic acid, may advantageously be prepared via free-radical-initiated copolymerization under high-pressure conditions, for example in stirred high-pressure autoclaves or in high-pressure tubular reactors, Preparation in stirred high-pressure autoclaves is preferred. Stirred high-pressure autoclaves are known per se, and a description is to be found in Ullmann's Encyclopedia of Industrial Chemistry, 5th edition, keyword: Waxes, vol. A 28, pp. 146 et seq., Verlag Chemie Weinheim, Basle, Cambridge, N.Y., Tokyo, 1996. Their length/diameter ratio is mainly in the range from 5:1 to 30:1, preferably from 10:1 to 20:1. The high-pressure tubular reactors which may also be used are likewise to be found in Ullmann's Encyclopedia of Industrial Chemistry, 5th edition, keyword: Waxes, vol. A 28, pp. 146 et seq., Verlag Chemie Weinheim, Basle, Cambridge, N.Y., Tokyo, 1996.

Suitable pressure conditions for the polymerization are from 500 to 4000 bar, preferably from 1500 to 2500 bar. The reaction temperatures are in the range from 170 to 300° C., preferably in the range from 200 to 280° C.

The copolymerization may be carried out in the presence of a regulator. Examples of regulators used are hydrogen or an aliphatic aldehyde or an aliphatic ketone of the general formula III

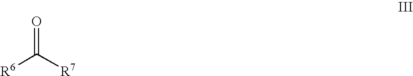

or a mixture of these.

The radicals R⁶ and R⁷ here are identical or different and have been selected from
hydrogen;
C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl, and tert-butyl; C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

In one particular embodiment, the radials R⁶ and R⁷ have covalent bonding to one another to form a 4- to 13-membered ring. By way of example, R⁶ and R⁷ may together be: —(CH₂)₄—, —(CH₂)₅—, —(CH₂)₆, —(CH₂)₇—, —CH(CH₃)—CH₂—CH₂—CH(CH₃)—, or —CH(CH₃)—CH₂—CH₂—CH₂—CH(CH₃)—.

Other regulators with good suitability are alkylaromatic compounds, such as toluene, ethylbenzene, or one or more isomers of xylene. It is preferable not to use aldehydes or ketones of the general formula III as regulators. It is particularly preferable not to add any regulators other than phlegmatizers, which can be added to ease the handling of organic peroxides and can also function as a molecular-weight regulator.

Initiators which may be used for the free-radical polymerization are the customary free-radical initiators, e.g. organic peroxides, oxygen, or azo compounds. Mixtures of two or more free-radical initiators are also suitable.

Examples of suitable peroxides selected from the substances available commercially are
didecanoyl peroxide, 2,5-dimethyl-2,5-di(2-ethylhexanoylperoxy)hexane, tert-amyl peroxy-2-ethylhexanoate, dibenzoyl peroxide, tert-butyl peroxy-2-ethylhexanoate, tert-butyl peroxydiethylacetate, tert-butyl peroxydiethylisobu-tyrate, 1,4-di(tert-butylperoxycarbonyl)cyclohexane in the form of isomer mixture, tert-butyl perisononanoate 1,1-di(tert-butylperoxy)-3,3,5-trimethylcyclohexane, 1,1-di(tert-butylperoxy)cyclohexane, methyl isobutyl ketone peroxide, tert-butylperoxy isopropyl carbonate, 2,2-di-tert-butylperoxybutane or tert-butyl per-oxyacetate;
ter-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropylbenzene monohy-droperoxide, cumene hydroperoxide or tert-butyl hydroperoxide, or
dimeric or trimeric ketone peroxides of the general formula IV a to IV c.

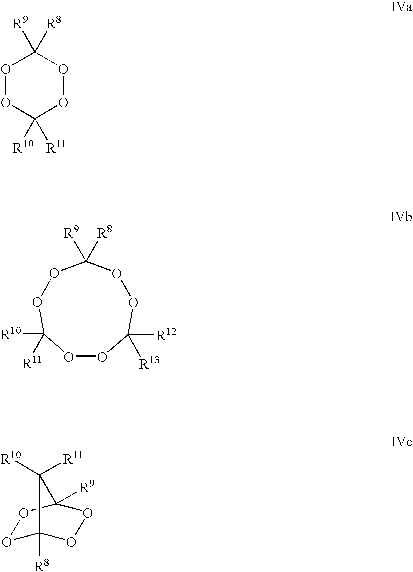

The radicals R⁸ to R¹³ here are identical or different and have been selected from
C₁-C₈-alkyl, such as methyl, ethyl, n-propyl, isopropyl, n-butyl, sec-butyl, isobutyl, tert-butyl, n-pentyl, sec-pentyl, isopentyl, n-hexyl, n-heptyl, n-octyl; preferably linear C₁-C₆-alkyl, such as methyl, ethyl, n-propyl, n-butyl, n-pentyl, n-hexyl, particularly preferably linear C₁-C₄-alkyl, such as methyl, ethyl, n-propyl or n-butyl, very particular preference being given to ethyl;
C₆-C₁₄-aryl such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

Peroxides of the general formulae IV a to IV c are disclosed in EP-A 0 813 550, as are processes for their preparation.

Particularly suitable peroxides are di-tert-butyl peroxide, tert-butyl peroxypivalate, tert-butyl peroxyisononanoate or dibenzoyl peroxide or mixtures of the same. An azo compound which may be mentioned by way of example is azobisisobutyronitrile (“AIBN”). The amounts added of free-radical initiators are those usual for polymerizations.

Numerous commercially available organic peroxides are treated with what are known as phlegmatizers prior to their sale in order to make their handling easier. Examples of suitable phlegmatizers are white oil or hydrocarbons, in particular isododecane. Under the conditions of high-pressure free-radical polymerization, these phlegmatizers can have the effect of regulating molecular weight. For the purposes of the present invention, the use of molecular weight regulators means the use of other molecular weight regulators in addition to the use of these phlegmatizers.

The quantitative ratio of the comonomers ethylene and ethylenically unsaturated carboxylic acid's) during the addition process is not usually precisely the same as the ratio of the units in a copolymer containing at least one ethylenically unsaturated carboxylic acid and used according to the invention as polymer (b) which is solid at room temperature and which contains carboxy groups and/or which contains carboxylic ester groups, because ethylenically unsaturated carboxylic acids are generally more readily incorporated than ethylene.

The comonomers are usually added together or separately.

The comonomers may be compressed in a compressor to the polymerization pressure. In another embodiment of the inventive process, the comonomers are first brought to an increased pressure, for example from 150 to 400 bar, preferably from 200 to 300 bar, and in particular 250 bar, with the aid of a pump, and then are brought to the actual polymerization pressure by a compressor.

The copolymerization may optionally be carried out in the absence or in the presence of solvents, but mineral oils, white oil, and other solvents present in the reactor during the polymerization and used to phlegmatize the free-radical initiator(s) are not solvents for the purposes of the present invention.

In one embodiment, the copolymerization is carried out in the absence of solvents.

Of course, it is also possible that copolymer containing at least one ethylenically unsaturated carboxylic acid and used according to the invention as polymer (b) which is solid at room temperature and which contains carboxy groups and/or which contains carboxylic ester groups is prepared by first copolymerizing ethylene with at least one ethylenically unsaturated carboxylic acid of the general formula II and then saponifying the ester groups in a polymer-analogous reaction, for example using potassium hydroxide solution or sodium hydroxide solution.

Examples of other highly suitable polymers which are solid at room temperature and which contain carboxy groups and/or which contain carboxylic ester groups are those selected from

styrene-acrylonitrile-C₁-C₁₀-alkyl (meth)acrylate terpolymers,
styrene-butadiene-n-butyl acrylate terpolymers,
styrene-maleic anhydride copolymers, preferably alternating styrene-maleic anhydride copolymers, which may have been partially or completely hydrolyzed,
(meth)acrylic acid-α-olefin copolymers, α-olefins being defined as above,
poly(meth)acrylic acid, polymethyl (meth)acrylate.

According to the invention, open-cell foam (a) is brought into contact with polymer (b) which is solid at room temperature and which contains carboxy groups and/or which contains carboxylic ester groups, and polymer (b) which is solid at room temperature and which contains carboxy groups and/or which contains carboxylic ester groups may be in molten or preferably dissolved or dispersed, in particular emulsified, form, in particular if polymer (b) which is solid at room temperature and which contains carboxy groups and/or which contains carboxylic ester groups is a copolymer of an ethylenically unsaturated carboxylic acid, it is preferable to use polymer (b) which is solid at room temperature and which contains carboxy groups and/or which contains carboxylic ester groups in dissolved or dispersed, in particular emulsified, form. It is particularly preferable to use polymer (b) which is solid at room temperature and which contains carboxy groups and/or which contains carboxylic ester groups dispersed or dissolved in water, in particular emulsified in water.

Examples of ways of bringing about the contact are via immersion of open-cell foam (a) in polymer (b) which is solid at room temperature and which contains carboxy groups and/or which contains carboxylic ester groups, via saturation of open-cell foam (a) with polymer (b) which is solid at room temperature and which contains carboxy groups and/or which contains carboxylic ester groups, via preferably complete spraying of open-cell foam (a) with polymer (b) which is solid at room temperature and which contains carboxy groups and/or which contains carboxylic ester groups, or via application of polymer (b) which is solid at room temperature and which contains carboxy groups and/or which contains carboxylic ester groups to open-cell foam (a) by calendering.

If polymer (b) which is solid at room temperature is used as dispersion or solution in water, it may be used in the form of aqueous formulations which comprise polymer (b) which is solid at room temperature and which contains carboxy groups and/or which contains carboxylic ester groups.

Aqueous formulations used according to the invention and comprising polymer (b) which is solid at room temperature and which contains carboxy groups and/or which contains carboxylic ester groups preferably comprise from 0.05 to 40% by weight, with preference from 10 to 35% by weight, of one or more polymers (b) which are solid at room temperature, these preferably being in completely or partially neutralized form.

In one embodiment of the present invention, aqueous formulations used according to the invention and comprising polymer (b) which is solid at room temperature and which contains carboxy groups and/or which contains carboxylic ester groups usually comprise, for the purpose of partial or complete neutralization, one or more substances with basic action, e.g. hydroxides and/or carbonates and/or hydrogencarbonates of alkali metals, or ammonia, or comprise organic amines, such as triethylamine, diethylamine, ethylamine, trimethylamine, dimethylamine, methylamine, ethanolamine, diethanolamine, triethanolamine, methyldiethanolamine, n-butyldiethanolamine, N,N-dimethylethanolamine. Aqueous formulations used according to the invention and comprising polymer (b) which is solid at room temperature and which contains carboxy groups and/or which contains carboxylic ester groups preferably comprise a sufficient amount of substance(s) having basic action to have neutralized at least one quarter, preferably at least a half, of the carboxy groups of the polymer(s) (b) which is solid at room temperature and which contains carboxy groups and/or which contains carboxylic ester groups. Substances having basic action may, by way of example, be added during dispersion or dissolution of polymer (b) which is solid at room temperature and which contains carboxy groups and/or which contains carboxylic ester groups, to formulations used according to the invention.

In one embodiment of the present invention, aqueous formulations used according to the invention and comprising polymer (b) which is solid at room temperature and which contains carboxy groups and/or which contains carboxylic ester groups comprise sufficient substance(s) having basic action to neutralize quantitatively the carboxy groups of the polymer(s) (b) which is solid at room temperature and which contains carboxy groups and/or which contains carboxylic ester groups.

Aqueous formulations used according to the invention and comprising polymer (b) which is solid at room temperature and which contains carboxy groups and/or which contains carboxylic ester groups usually have basic pH, determined to DIN 19268, for example. pH values of from 7.5 to 14 are preferred, and those from 8 to 10 are particularly preferred, and those from 8.5 to 10 are very particularly preferred.

If the intention is to use polymer (b) which is solid at room temperature and which contains carboxy groups and/or which contains carboxylic ester groups in solution, other solvents which may be used, besides water, are organic solvents. Examples of suitable organic solvents are

aromatic hydrocarbons, such as toluene, ortho-xylene, meta-xylene, para-xylene, ethylbenzene;
aliphatic hydrocarbons, such as n-dodecane, isododecane (2,2,4,6,6-pentamethyl-heptane), n-tetradecane, n-hexadecane, n-octadecan, and isomers, individually or mixed, of the abovementioned aliphatic hydrocarbons, in particular the mixture available commercially as solvent naphtha, composed of various C₁₂-C₁₈ hydrocarbons;
ethers, in particular cyclic ethers, such as tetrahydrofuran (THF) and 1,4-dioxane;
mixtures of the abovementioned aliphatic or aromatic hydrocarbons with from 0.1 to 10% by weight of alcohols or ethers, e.g. n-hexanol, n-octanol, n-pentanol, tetrahydrofuran, or 1,4-dioxane;
chlorinated hydrocarbons, such as chlorobenzene, ortho-dichlorobenzene, meta-dichlorobenzene.

Suitable concentrations of polymer (b) which is solid at room temperature and which contains carboxy groups and/or which contains carboxylic ester groups in a solvent or mixture of solvents are from 0.001 to 75% by weight, preferably from 0.01 to 28% by weight, for example.

In one embodiment of the present invention, following the contact process, (a) and (b) may permitted to interact, for example over a period in the range from 1 second to 24 hours, preferably from 5 seconds to 10 hours, and particularly preferably from 10 seconds to 6 hours.

In one embodiment of the inventive production process, open-cell foam (a) and polymer (b) which is solid at room temperature and which contains carboxy groups and/or which contains carboxylic ester groups are brought into contact at temperatures in the range from 0° to 250° C., preferably from 5° C. to 190° C., and particularly preferably from 10° C. to 165° C.

In one embodiment of the inventive production process, open-cell foam (a) and polymer (b) which is solid at room temperature and which contains carboxy groups and/or which contains carboxylic ester groups are first brought into contact at temperatures in the range from 00° C. to 50° C., and then the temperature is changed, for example raised to temperatures in the range from 60° C. to 250° C., preferably from 65° C. to 180° C.

In another embodiment of the inventive production process, open-cell foam (a) and polymer (b) which is solid at room temperature and which contains carboxy groups and/or which contains carboxylic ester groups are first brought into contact at temperatures in the range from 0° C. to 120° C., and then the temperature is changed, for example raised to temperatures in the range from 30° C. to 250° C., preferably from 125° C. to 200° C.

In one preferred embodiment of the inventive process, the selection of solvent and the temperature profile are such that there is no substantial alteration in most of the structure parameters of open-cell foam (a) used as starting material.

In another preferred embodiment of the present invention, the selection of the amounts of the starting materials—open-cell foam (a), polymer (b) which is solid at room temperature and which contains carboxy groups and/or which contains carboxylic ester groups, and, if appropriate, additives (c)—is such that inventive product has markedly higher density than the relevant open-cell foam (a) used as starting material.

In one embodiment of the present invention, operations to carry out the inventive production process are carried out at atmospheric pressure. In another embodiment of the present invention, operations for carrying out the inventive process are carried out at elevated pressure, for example at pressures in the range from 1.1 bar to 10 bar. In another embodiment of the present invention, operations for carrying out the inventive production process are carried out at reduced pressure, for example at pressures in the range from 0.1 mbar to 900 mbar, preferably up to 100 mbar.

In one embodiment of the present invention, open-cell foam (a) is brought into contact with polymer (b) which is solid at room temperature and which contains carboxy groups and/or which contains carboxylic ester groups in such a way that polymer (b) which is solid at room temperature becomes distributed with maximum uniformity in all dimensions over open-cell foam (a). Suitable methods are methods effective for application purposes. Examples which may be mentioned are: complete saturation, immersion, flow coating, drum-application, spray-application, e.g. compressed-air spraying, airless spraying, and high-speed rotary atomization, and also coating, doctor-application, calender-application, spreading, roller-application, wiper-application, and rolling.

In another embodiment of the present invention, open-cell foam (a) is brought into contact with polymer (b) which is solid at room temperature and which contains carboxy groups and/or which contains carboxylic ester groups in such a way as to bring about uniform distribution of polymer (b) which is solid at room temperature and which contains carboxy groups and/or which contains carboxylic ester groups on open-cell foam (a). For example, in one embodiment of the present invention open-cell foam (a) may be sprayed non-uniformly with polymer (b) which is solid at room temperature and which contains carboxy groups and/or which contains carboxylic ester groups and the materials may then be allowed to interact. In another embodiment of the present invention, open-cell foam (a) may be incompletely saturated with polymer (b) which is solid at room temperature. In another embodiment of the present invention, a portion of open-cell foam (a) may be brought into contact once, and another portion of open-cell foam (a) may be brought into contact at least twice, with polymer (b) which is solid at room temperature and which contains carboxy groups and/or which contains carboxylic ester groups. In another embodiment, open-cell foam (a) is saturated and the uppermost layer is rinsed clean with, by way of example, water. The materials are then allowed to interact. The result is coating within the core of open-cell foam (a), the outer surface remains uncoated.

If open-cell foam (a) is brought into contact with polymer (b) which is solid at room temperature and which contains carboxy groups and/or which contains carboxylic ester groups in such a way that non-uniform distribution of polymer (b) which is solid at room temperature and which contains carboxy groups and/or which contains carboxylic ester groups has been brought about on open-cell foam (a), the effect achieved by, for example, allowing the materials to interact over a period of 2 minutes or more is that not just the outermost layer of open-cell foam (a) is brought into contact with polymer (b) which is solid at room temperature and which contains carboxy groups and/or which contains carboxylic ester groups.

If open-cell foam (a) is brought into contact with polymer (b) which is solid at room temperature and which contains carboxy groups and/or which contains carboxylic ester groups in such a way as to bring about non-uniform distribution of polymer (b) which is solid at room temperature and which contains carboxy groups and/or which contains carboxylic ester groups on open-cell foam (a), modified foam may, according to the invention, have mechanical properties that are non-uniform over its cross section. For example, according to the invention it is possible that it is harder at those sites where it has been brought into contact with relatively large proportions of at least one polymer (b) which is solid at room temperature and which contains carboxy groups and/or which contains carboxylic ester groups than at those sites where it has been brought into contact with a smaller amount of polymer (b) which is solid at room temperature and which contains carboxy groups and/or which contains carboxylic ester groups.

In one embodiment of the present invention, rinsing may be carried out, for example using one or more solvents, and preferably using water, after contact.

In one embodiment of the present invention, after contact and after optional rinsing, drying may be carried out, for example mechanical drying, e.g. via squeezing or calendering, in particular via squeezing through two rollers, or thermally, for example in microwave ovens, hot-air blowers, or drying cabinets, in particular vacuum drying cabinets, the possible temperatures at which drying cabinets are operated being temperatures which are below the softening point or melting Hint of polymer (b) which is solid at room temperature and which contains carboxy groups and/or which contains carboxylic ester groups by from 25 to 10° C. In the context of vacuum drying cabinets, vacuum may mean a pressure in the range from 0.1 to 850 mbar, for example.

The time taken for any desired drying steps is by definition excluded from the interaction time for the purposes of the present invention.

In one embodiment of the present invention, thermal drying may be brought about via heating to temperatures in the range from 20° C. to 150° C., for example over a period of from 10 seconds to 20 hours. It is preferable to carry out heating to a temperature which is above, by at least 20° C., the glass transition temperature of polymer (b) which is solid at room temperature and which contains carboxy groups and/or which contains carboxylic ester groups, preferably to a temperature which is above, by at least 30° C., the glass transition temperature of polymer (b) used which is solid at room temperature. It is preferable to carry out heating to a temperature which is below the melting or drop point of polymer (b) used which is solid at room temperature and which contains carboxy groups and/or which contains carboxylic ester groups, for example below the melting or drop point of polymer (b) used which is solid at room temperature and which contains carboxy groups and/or which contains carboxylic ester groups by at least 5° C.

If a mixture of at least two different polymers (b) which are solid at room temperature and which contain carboxy groups and/or which contain carboxylic ester groups has been used, and if thermal drying is desired, heating is carried out to a temperature which is above by at least 20° C., preferably at least 30° C., the glass transition temperature of the higher-glass-transition-temperature polymer (b) which are solid at room temperature and which contain carboxy groups and/or which contain carboxylic ester groups. If a mixture of at least two different polymers (b) which are solid at room temperature and which contain carboxy groups and/or which contain carboxylic ester groups has been used, and if thermal drying is desired, heating is preferably carried out to a temperature which is below the melting point or drop point of all of the polymers (b) used which are solid at room temperature and which contain carboxy groups and/or which contain carboxylic ester groups, for example below the melting or drop point of the lowest-melting-point or lowest-drop-point polymer (b) which is solid at room temperature and which contains carboxy groups and/or which contains carboxylic ester groups, by at least 5° C.

In one embodiment of the present invention, at least one open-cell foam (a) may not only be brought into contact with at least one polymer (b) which is solid at room temperature and which contains carboxy groups and/or which contains carboxylic ester groups, but may also be brought into contact with at least additive (c) selected from:

biocides, such as silver particles or monomeric or polymeric organic biocides, such as phenoxyethanol, phenoxypropanol, glyoxal, thiadiazines, 2,4-dichlorobenzyl alcohols, and preferably isothiazolone derivatives, such as MIT (2-methyl-3(2H)-isothiazolone), CMIT (5-chloro-2-methyl-3(2H)-isothiazolone), CIT (5-chloro-3(2H)-isothiazolone), BIT (1,2-benzoisothiazol-3(2H)-one), and also copolymers of N,N-di-C₁-C₁₀-alkyl-ω-amino-C₂-C₄-alkyl (meth)acrylate, in particular copolymers of ethylene with N,N-dimethyl-2-aminoethyl (meth)acrylate,
solids, e.g. abrasive materials, e.g. sand, silicates with an average particle diameter (number-average) in the range from 1 um to 1 mm, or colloidal silica,
one or more surfactants, which may be anionic, cationic, or non-ionic,
dissolved materials as constituents of polymer (b) which is solid at room temperature and which contains carboxy groups and/or which contains carboxylic ester groups, activated charcoal,
colorants, such as dyes or pigments,
fragrances, e.g. perfume,
odor scavengers, such as cyclodextrins, and
microcapsules charged with at least one active ingredient, such as treatment oil, with one or more biocides, perfume, or odor scavenger, and for the purposes of the present invention the microcapsules may be, by way of example, spherical hollow particles with an average external diameter in the range from 1 to 100 μm, which may be composed, by way of example, of melamine-formaldehyde resin or of polymethyl methacrylate.

An example of a procedure for this purpose brings at least one open-cell foam (a) into contact, in different operations or preferably simultaneously, with at least one polymer (b) which is solid at room temperature and which contains carboxy groups and/or which contains carboxylic ester groups and with at least additive (c) in one embodiment of the present invention, one or more additives (c) may be added, for example in proportions of from 0 to a total of 50% by weight, based on (b), preferably from 0.001 to 30% by weight, particularly preferably from 0.01 to 25% by weight, very particularly preferably from 0.1 to 20% by weight, to aqueous formulation used according to the invention and comprising polymer (b) which is solid at room temperature and which contains carboxy groups and/or which contains carboxylic ester groups.

In one embodiment of the present invention, inventive modified foams or foams produced by the inventive process are in essence open-cell foams, i.e. foams in which at least 50% of all lamellae are open, preferably from 60 to 100%, and particularly preferably from 65 to 99.8%, determined to DIN ISO 4590

Inventive modified foams or foams produced by the inventive process have an advantageous range of properties. They have improved cleaning power or cleaning action, good resistance to hydrolysis, improved resistance to acid, good sound absorption, and—for example if used to produce cleaning materials—good durability. Soiling of the foams proceeds very slowly. Any inventive foams which may have become soiled can readily be cleaned without irreversible damage, Foams modified according to the invention or inventive modified foams moreover have high resistance to oxidants, in particular to gaseous oxidants, such as ozone and oxygen.

In one embodiment of the present invention, inventive modified foams may be produced by not only treating unmodified open-cell foam (a) with at least one polymer (b) which is solid at room temperature and which contains carboxy groups and/or which contains carboxylic ester groups and, if appropriate, with at least one additive (c), but also treating it with at least one crosslinking agent (d). Preferred crosslinking agents (d) are selected from metal alcoholates and polyfunctional epoxides.

Preferred metal alcoholates are one or more alcoholates of polyvalent metals, preferably of di- or trivalent metals, particularly preferably of trivalent metals. Examples of divalent metals which may be mentioned are Zn²⁺, Ca²⁺, Mg²⁺, Cu²⁺. Examples of trivalent metals which may be mentioned are Fe³⁺, Cr³⁺, Ti³⁺, V³⁺ and very particularly preferably Al³⁺.

Metal alcoholates which may be used are mixed alcoholates, for example mixed ethanolates/methanolates, or else mixtures of various alcoholates, e.g. mixtures of ethanolates and methanolates or of ethanolates and isopropoxides. However, pure alcoholates are preferably used.

Examples of metal aicoholates which may be used are metal alkanolates, e.g. metal methanolates, metal ethanolates, isopropoxides, metal tert-butoxides, and also metal phenolates, and in particular metal enolates. It is preferable to use metal alcoholates of those alcohols whose boiling point at atmospheric pressure is up to 150° C. Very particular preference is given to enolates of the general formula V

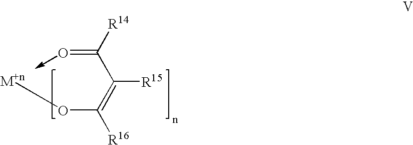

where the variables have the following definitions:
M⁺ⁿ is a cation of an n-valent metal, such as Na⁺, K⁺, preferably Ca²⁺, Mg²⁺, Fe³⁺, Cr³⁺, Ti³⁺, V³⁺, and very particularly preferably Al³⁺,
n is a whole number in the range from 1 to 4, preferably from 2 to 3, and very particularly preferably 3,
R¹⁵ is hydrogen or methyl,
R¹⁴ and R¹⁶ are different or preferably identical, and selected from
   C₁-C₄-alkyl, such as methyl, ethyl, n-propyl, isopropyl, n-butyl, isobutyl, sec-butyl, and tert-butyl, in particular methyl,
   phenyl,
   C₁-C₆-alkoxy, such as methoxy, ethoxy, n-propoxy, isopropoxy, n-butoxy, isobutoxy, sec-butoxy, tert-butoxy, n-pentoxy, isopentoxy, n-hexoxy, and isohexoxy, preferably methoxy, ethoxy, n-propoxy, and n-butoxy, and particularly preferably ethoxy.
R¹⁴ and R¹⁶ are very particularly preferably identical and are methyl.

Crosslinking agents (d) and in particular metal alcoholate are preferably used in one or more solvents. Particular solvents suitable for crosslinking agents (d) are aprotic organic solvents, Those with particularly good suitability are cyclic and non-cyclic ethers, such as tetrahydrofuran, 1,4-dioxane, tetrahydropyran, diisopropyl ether, di-n-butyl ether, and mixtures of the abovementioned solvents, very particularly tetrahydrofuran.

In one embodiment of the present invention, the amount of metal alcoholate used is in the range from 1 to 10% by weight, based on polymer (b) which contains carboxy groups or which contains carboxylic ester groups, preferably from 2 to 5% by weight.

In one specific embodiment of the present invention, the procedure may be to use amounts of metal alcoholate and polymer (b) which contains carboxy groups such that the molar ratio of COOH groups from polymer (b) which contains carboxy groups to metal cations is in the range from 1:1 to 1:6.

In another embodiment of the present invention, polymer (b) which contains carboxy groups or which contains carboxylic ester groups is first mixed with metal alcoholate and the material is then treated with one or more of the abovementioned solvents, and the quantitative ratios here may be as mentioned above.

The solvent(s) is/are then slowly evaporated, for example at room temperature or at slightly elevated temperature, e.g. at 30 or 35° C. As the solvent(s) evaporate(s), a film of homogeneous appearance forms.

In order to facilitate the evaporation process, operations may be carried out under reduced pressure, for example at pressures in the range from 100 to 990 mbar.

According to the invention, the evaporation residue is then heat-treated.

In one embodiment of the present invention, the evaporation residue may be stored for from 5 to 48 hours, preferably from 12 to 36 hours, at a temperature in the range from 45 to 130° C., preferably from 60 to 120° C.

In another embodiment of the present invention, the evaporation residue may be heated in stages. For example, heating may be first carried out to from 70 to 90° C., and followed by storage for from 1 to 5 hours at from 70 to 90° C., and then by heating to from 110 to 130° C., and further storage for from 1 to 5 hours.

Without any intention to give preference to any particular theory, it is likely that at least two acid radicals belonging to different molecules of polymer (b) which contains carboxy groups, in deprotonated form, form an adduct with a polyvalent metal cation.

In another embodiment, polymer (b) which contains carboxy groups or which contains carboxylic ester groups is mixed with one or more polyfunctional epoxides and with at least one solvent, these possibly having been selected as stated above.

Examples of polyfunctional epoxides which may be used are dendrimeric epoxides having at least two epoxy groups, and also hyperbranched polymers having at least two epoxy groups, the hyperbranched polymers differing from dendrimers in their molecular non-uniformity; see, for example, Nachrichten aus Chemie, Technik und Laboratorium, 2002, 50, 1218.

Particularly suitable polyfunctional epoxides are polyfunctional epoxides of the general formula VI:

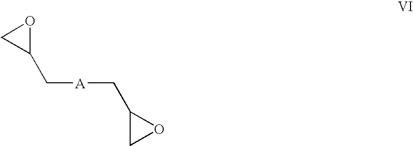

in which A can be selected as follows:
C₁-C₂₀-alkylene, unsubstituted or substituted with one or more C₁₋₄-alkyl groups, with one or more C₆₋₁₄-aryl groups, with one or more OH groups which may have been etherified with C₁-C₆-alkanol or with glycidyl alcohol, where one or more non-adjacent carbon atoms may also be replaced by oxygen, preference is given to —CH₂—, —H₂—CH₂—, —(CH₂)₃—, —(CH₂)₄—, —(CH₂)₅—, —(CH₂)₆—, —(H₂)₁₀—, —(CH₂)₂₀—, —CH(CH₃)—, —CH(C₂H₅)—, —CH(C₆H₅)—, —CH(OH)—, —[CH(OH)]₂—, —CH(OCH₃)—,
   —CH(OC₂H₅)—, —CH(O-glycidyl)-;
   —O—(CH₂)₂—O—, —O—(CH₂)₄—O—, —[O—(CH₂)₂]₂—O—, —[O—(CH₂)₂]₃—O—, —[O—(CH₂)₂]₄—O—, C₄-C₁₀-cycloalkylene, such as cis- or trans-1,3-cyclobutylene, cis- or trans-1,3-cyclopentylene, cis- or trans-1,4-cyclohexylene,
   C₆-C₁₄-arylene, such as meta-phenylene, para-phenylene, 4,4′-biphenylene,

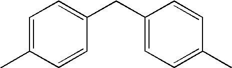

nitrogen, substituted with C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl, and tert-butyl, in particular methyl;
nitrogen, substituted with C₆-C₁₄-aryl, which in turn may have substitution with one or more C₁-C₄-alkyl groups, with one or more C₆-C₁₄-awl groups, with one or more OH groups, which may have been etherified with C₁-C₆-alkanol or with glycidyl alcohol.

Polyfunctional epoxides used with particular preference have the formulae VI a to VI h

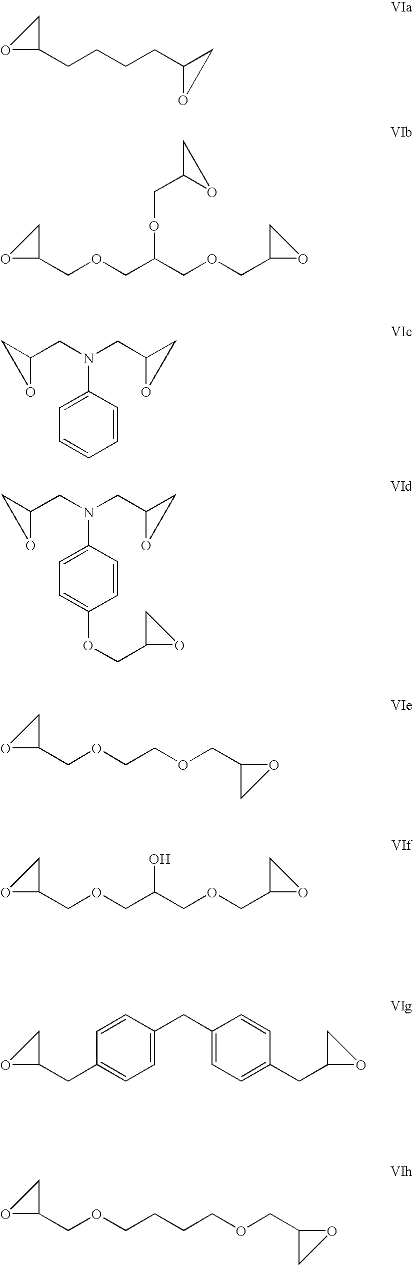

To produce materials for substance-separation processes, an example of a process combines polyfunctional epoxide and ethylene copolymer in amounts such that the molar ratio of COOH groups from ethylene copolymer to epoxy groups is in the range from 100:1 to 1:1, preferably from 30:1 to 10:1.

In one embodiment of the present invention, polymer (b) which contains carboxy groups or which contains carboxylic ester groups and polyfunctional epoxide are dissolved in at least one solvent, preferably THF. The solvent(s) is/are allowed to evaporate. Heat-treatment is then carried out at temperatures in the range from 70 to 150° C., preferably from 90 to 120° C., giving a specific embodiment of inventive modified foam.

The present invention also provides the use of inventive modified open-cell foams or of inventively modified open-cell foams for production of cleaning materials, such as

wipers, brushes, cleaning cloths, or cleaning granules,
filters, such as air filters, pond filters, aquarium filters, water filters, or else as a matrix for ceramic filters,
humidifiers, water distributors,
packaging elements, in particular for impact- or water-sensitive products,
sound-deadening elements, buildings-insulation materials, in particular roof-insulation materials and wall-insulation materials.

The present invention also provides a process for production of cleaning materials, using inventive modified open-cell foams or using inventively modified open-cell foams. The present invention also provides a process for production of filters, using inventive modified open-cell foams, or using inventively modified open-cell foams. The present invention also provides a process for production of humidifiers, using inventive modified open-cell foams, or using inventively modified open-cell foams. The process invention also provides a process for production of water distributors, using inventive modified open-cell foams, or using inventively modified open-cell foams. The present invention also provides a process for production of packaging elements, using inventive modified open-cell foams, or using inventively modified open-cell foams. The present invention also provides a process for production of sound-deadening elements, using inventive modified open-cell foams, or using inventively modified open-cell foams. The present invention also provides a process for production of buildings-insulation materials, using inventive modified open-cell foams, or using inventively modified open-cell foams.

If the intention is to use inventive modified foams for production of filters, preference is given to sack filters and matrices of ceramic filters. If the intention is to use inventive modified foams for production of automobile parts, ventilation units are particularly preferred.

The present invention also provides cleaning materials, filters, humidifiers, water distributors, packaging elements, sound-deadening elements, and buildings-insulation materials produced using, or comprising, inventive modified open-cell foams or inventively modified open-cell foams.

By way of example, inventive modified foams may be bonded to other materials, for example to poles, bases for, by way of example, brooms and brushes, or to textiles, leather, polyurethane, or wood.

The invention is illustrated via examples.

### EXAMPLES

### I. Production, in Dispersed Form, of a Polymer (b.1) which is Solid at Room Temperature and which Contains Carboxy Groups and/or which Contains Carboxylic Ester Groups

I.1. Production of a Methacrylic Acid Copolymer which is Solid at Room Temperature

Ethylene and methacrylic acid were copolymerized in a high-pressure autoclave described in the literature (M. Buback et al., Chem. Ing. Tech 1994, 66, 510). To this end, ethylene (12.3 kg/h) was fed at the reaction pressure of 1700 bar into the autoclave. Separately from this, 1.04 l/h of methacrylic acid were first compressed to an intermediate pressure of 260 bar and then fed under the reaction pressure of 1700 bar. Separately from this, 2 l/h of an initiator solution composed of tert-amyl peroxypivalate (0.13 mol·l⁻¹ in isododecane) was fed, under the reaction pressure of 1700 bar, into the autoclave. The reaction temperature was 220° C. This gave 3.4 kg/h of methacrylic acid copolymer (b.1) which is solid at room temperature with the following properties: 26,2% by weight of methacrylic acid, 73.86 by weight of ethylene, melting range 75-85° C., measured to DIN 51007, ρ 0.9613 g/cm³, MFI 10.5 g/10 min, measured at 120° C. with a load of 325 g to DIN 53735, acid number 170.5 mg KOH/g (determined to EN ISO 3682).

The content of ethylene and methacrylic acid in (b.1) was determined via NMAR spectroscopy and, respectively, titration (acid number). The acid number of (b.1) was determined titrimetrically to DIN 53402. The KOH consumption corresponds to the methacrylic acid content in (b.1).

I.2. Preparation of an Aqueous Dispersion of a Polymer (b.1) which is Solid at Room Temperature and which Contains Carboxy Groups and/or which Contains Carboxylic Ester Groups

### I.2.1 Preparation of an Aqueous Dispersion DL

250 g of ethylene copolymer (b.1) of Example 1.1, 34 g of 25% by weight aqueous ammonia solution, and 716 ml of deionized water were used as initial charge in a 2-liter stirred tank with anchor stirrer and reflux condenser. The materials were heated to 95° C., with stirring, and were stirred for three hours at 95° C. This gave aqueous dispersion D1 with pH 8.5. The solids content of D1 was 25.3% by weight.

### I.2.2 Preparation of an Aqueous Dispersion D2

206.8 g of ethylene copolymer (b.1) of Example 0.1, 34.9 g of N,N-dimethylethanolamine, and 758.3 ml of deionized water were used as initial charge in a 2-liter stirred tank with anchor stirrer and reflux condenser. The materials were heated to 95° C., with stirring, and were stirred for three hours at 95° C. This gave aqueous dispersion D2 with pH 8.5. The solids content of D2 was 21% by weight.

### I.2.3 Preparation of Dilute Aqueous Dispersions

Each of dispersions D1 and D2 was diluted with deionized water at room temperature to solids contents of 10%, 5%, 2%, and 1%. This gave the dilute aqueous dispersions D1.10, D0105, D1.02 and D1.01, and D2.10, D2.05, D2.02 and D2.01, respectively.

### II. Production of an Inventive Modified Foam

### II.1 Production of Unmodified Foam (a)

A spray-dried melamine-formaldehyde precondensate (molar ratio 1:3, molecular weight about 500) was added, in an open vessel, to an aqueous solution with 3% by weight of formic acid and 1.5% of the sodium salt of a mixture of alkylsulfonates having from 12 to 13 carbon atoms in the alkyl radical and (K 30 emulsifer from Bayer AG), the percentages being based on the melamine-formaldehyde precondensate. The concentration of the melamine-formaldehyde precondensate, based on the entire mixture composed of melamine-formaldehyde precondensate and water, was 74% The resultant mixture was vigorously stirred, and then 20% of n-pentane were added. Stirring was continued (for about 3 min) until a dispersion of homogeneous appearance was produced. This was applied, using a doctor, onto a Teflon-treated glass fabric as substrate material and foamed and cured in a drying cabinet in which the prevailing air temperature was 150° C. The resultant temperature within the foam composition was the boiling point of n-pentane, which was 37.0° C. under these conditions. After from 7 to 8 min, the foam had risen to its maximum height. The foam was then left for a further 10 min at 150° C. in the drying cabinet; it was then heat-conditioned for 30 min at 180° C. This gave unmodified foam (a.1)

### II.2 Production of Inventive Modified Foams F1

The following properties were determined on the unmodified foam (al) from Inventive Example II.1:

open-cell factor to DIN ISO 4590: 99.6%,
compressive strength (40%): 1.3 kPa, determined to DIN 53577,
density: 10.0 kg/m³, determined to EN ISO 845,
average pore diameter: 210 μm, determined via evaluation of micrographs of sections,
BET surface area: 6.4 m²/g, determined to DIN 66131,
sound absorption: 93%, determined to DIN 52215,
sound absorption: more than 0.9, determined to DIN 52212.

Unmodified foam (al) from inventive Example 1.1 was cut into foam blocks with dimensions 9 cm·4 cm·4 cm. The weight of the foam blocks was in the range from 1.20 to 1.33 g. The material was then brought into contact with aqueous dispersion D1.10, by dipping each foam block completely into aqueous dispersion D1.10 and allowing it to remain covered by aqueous dispersion D1.10 for 10 seconds. The foam blocks were then removed from the relevant aqueous dispersion and excess aqueous dispersion was removed by squeezing, by passing the material between counter-rotating rolls having a diameter of 150 mm and a separation of 5 mm and rotating at a speed of 32 rpm.

The material was then dried for a period of 10 hours at 60° C. in a drying cabinet. This gave inventive modified foam F1.10

### II.3 Production of Further Inventive Modified Foams

The experiment of 11.2 was repeated, but using a dispersion of Table 1 on each occasion. This gave inventive modified foams.

TABLE 1
Inventive modified foams

| | Inventive | Weight of | Weight of inventive | |
|---|---|---|---|---|
| Disper- | modified | unmodified foam | modified foam block | Δ [% by |
| sion | foam No. | block [g] | [g] | weight] |
| D1.10 | F1.10 | 120 | 4.47 | 272.5 |
| D1.05 | F1.05 | 1.33 | 2.68 | 101.5 |
| D1.02 | F1.02 | 1.26 | 1.63 | 29.4 |
| D1.01 | F1.01 | 1.22 | 1.37 | 12.3 |
| D2.10 | F2.10 | 1.29 | 3.61 | 179.8 |
| D2.05 | F2.05 | 1.23 | 3.31 | 169.1 |
| D2.02 | F2.02 | 1.21 | 1.68 | 38.8 |
| D2.01 | F2.01 | 1.23 | 1.49 | 21.1 |

### III. Use of Inventive Modified Foams and of Unmodified Foams as Wipers

Inventive modified foams and unmodified foam were in each case used as wipers.

Inventive modified foams and unmodified foams were in each case moistened with water.

One of the inventive modified foams from II.2 or II.3, and unmodified foam of III.1 were used for manual cleaning, over a period of 2 minutes, of about 1 m² of a painted plasterboard wall (rough) which had been soiled with streaks of abraded rubber, shoe polish, and used oil. This gave cleaned walls of Table 2, the cleaning quality of which was assessed visually. The dimensional stability of the wipers was also assessed visually.

TABLE 2
Unmodified foam (a.1) from II.1, and inventive modified foams and
their use as wipers

| | | Dimensional |
|---|---|---|
| | Cleaning | stability of |
| Foam | quality | foam |
| (a.1) | satisfactory | severe loss of shape |
| | | after 2 minutes |
| F1.10 | very good | no loss of shape |
| F1.5 | very good | no loss of shape |
| F1.2 | good | no loss of shape |
| F1.1 | good | slight loss of shape |
| F2.10 | very good | no loss of shape |
| F2.5 | very good | no loss of shape |
| F2.2 | good | no loss of shape |
| F2.2 | good | slight loss of shape |

1. A modified open-cell aminoplastic foam having a density in the range from 5 to 1000 kg/m³ and an average pore diameter in the range from 1 μm to 1 mm, comprising from 1 to 2500% by weight, based on the weight of the unmodified open-cell aminoplastic foam, of at least one polymer that is solid at room temperature and contains carboxy groups and/or carboxylic ester groups, and has a molar mass Mn in the range from 1000 to 1 000 000 g/mol.

2. A process for production of modified open-cell aminoplastic foams, the process comprising
contacting an open-cell aminoplastic foam (a) with a density in the range from 5 to 500 kg/m³ and with an average pore diameter in the range from 1 μm to 1 mm
with at east one polymer (b) that is solid at room temperature and contains carboxy groups and/or which contains carboxylic ester groups, and has a molar mass Mₙ in the range from 1000 to 1 000 000 g/mol in molten, dissolved, or dispersed form.

3. The process according to claim 2, wherein at least one polymer (b) is a copolymer of an ethylenically unsaturated carboxylic acid.

4. The process according to claim 2, wherein at least one polymer (b) is a copolymer obtained via copolymerization of
(A) ethylene,
(B) at least one ethylenically unsaturated carboxylic acid, and
(C) if appropriate, other comonomers.

5. The process according to claim 2, wherein at least one polymer (b) is first dispersed in an aqueous medium and then brought into contact with unmodified aminoplastic foam (a).

6. The process according to claim 2, wherein the open-cell aminoplastic foam (a) is melamine foam.

7. The process according to claim 2, wherein at least one open-cell aminoplastic foam (a) is brought into contact with at least one additive (c) selected from biocides, solids, dissolved materials as constituents of the polymer (b), surfactants, colorants, activated charcoal, fragrances, odor scavengers, and microcapsules charged with at least on active ingredient.

8. A cleaning material, a filter, a humidifier, a water distributor, a packaging element, a sound-deadening element, or a building insulation material comprising a modified open-cell aminoplastic foam according to claim 1.

9. A process for production of cleaning materials, filters, humidifiers, water distributors, packaging elements, sound-deadening elements, or buildings-insulation materials, comprising using modified open-cell aminoplastic foams according to claim 1.

10. A cleaning material, a filter, a humidifier, a water distributor, a packaging element, a sound-deadening element, or a buildings-insulation material, comprising a modified open-cell aminoplastic foam produced by a process according to claim 2.

11. (canceled)
